(19) United States
(12) Patent Application Publication
(10) Pub. No.: US 2025/0215734 A1
(43) Pub. Date: Jul. 3, 2025

(54) Sliding Door Arrangement For Shelving Unit Having Secure Storage Space

(71) Applicant: InterMetro Industries Corporation, Wilkes- Barre, PA (US)

(72) Inventors: Brock ROMANTIC, Larksville, PA (US); Michael Joseph GROCHOWSKI, Mountain Top, PA (US)

(73) Assignee: InterMetro Industries Corporation, Wilkes- Barre, PA (US)

(21) Appl. No.: 18/979,874

(22) Filed: Dec. 13, 2024

Related U.S. Application Data
(60) Provisional application No. 63/616,128, filed on Dec. 29, 2023.

(51) Int. Cl. E05D 15/06

(52) U.S. Cl. CPC E05D 15/0643; E05Y 2900/20

(57) ABSTRACT

A shelving unit incorporating a secure storage space (a security cage cart) having side-by-side lockable sliding doors for accessing the secure space of the shelving unit is disclosed. The sliding door arrangement minimizes the overall footprint needed to operate and use the security cage cart. A door latching mechanism having a single lock position for both sliding doors is also disclosed. The door latching mechanism can secure both doors in the closed position independent of whether a padlock is also used.

### CROSS-REFERENCE TO RELATED APPLICATIONS

This application claims the benefit of U.S. Provisional Application No. 63/616,128, filed on Dec. 29, 2023. The entire disclosure of the above application is incorporated herein by reference.

### FIELD

The present disclosure relates to a shelving unit incorporating a secure storage space having sliding doors for accessing the secure space of the shelving unit.

### BACKGROUND

This section provides background information related to the present disclosure which is not necessarily prior art.

Shelving and storage units incorporating a secure storage space (e.g., security cages) are known. The security cages have lockable doors for providing access to an enclosed storage space. In some shelving units, the doors can be hinged to open and close. In other storage units, the doors can slide to open and close.

Hinged-door security cage shelving units require sufficient space to allow easy operation of the doors and/or easy access to articles stored in the secure storage space of the unit. For example, a hinged-door security cage shelving unit can be difficult to use or operate and/or can create an obstacle when employed in narrow spaces (e.g., in a hallway or in a high-density shelving track arrangement). Hinged-door security cage shelving units can be stationary or mobile; however, they are typically stand-alone units. As such, it becomes difficult to specify and incorporate security cage shelving units in a comprehensive storage plan because the security cage shelving units require an operational footprint disproportionate to other storage units.

Security cage storage units 4 that provide sliding door access are commonly fixed installations. See, e.g., FIGS. 1 and 2. Often, such installations utilize a single sliding door 6 to facilitate walk-in access to a cage 8 defining a secure storage space 10. See, e.g., FIG. 1. Other such installations can provide two sliding doors 14 and 16 side-by-side that provide reach-in access to stored articles 18 in the secure space 10. See, e.g., FIG. 2. The side-by-side sliding door installations are employed in conditions where the ability for a user to enter the secure space 10 is limited or non-existent. Fixed security storage unit installations tend to be large, permanent structures and require professional installation.

### SUMMARY

This section provides a general summary of the disclosure and is not a comprehensive disclosure of its full scope or all of its features.

The present disclosure provides a shelving unit incorporating a secure storage space (e.g., a security cage cart) having a side-by-side lockable sliding door arrangement for providing access to the secure storage space. The sliding door arrangement minimizes the overall footprint needed to operate and use the security cage cart (e.g., open and close the doors) and access the secure storage space. Consequently, the security cage cart of the present disclosure can be used in a broader range of environments, including in tight spaces and in high-density track applications.

In another aspect, the present disclosure provides a door latching mechanism suitable for use in a security cage cart having a side-by-side sliding door arrangement. The door latching mechanism provides a single locked condition for both sliding doors. The door latching mechanism can secure both doors in the closed position independent of whether a supplemental locking device (e.g., a padlock) is also used. A pivot latch of the door latching mechanism has a locked position and an unlocked position. In the locked position of the pivot latch, the doors are secured closed and cannot open. In the unlocked position of the pivot latch, the doors are free to open and close.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a front perspective view of a known fixed, walk-in secure storage installation having a single sliding door entry into the secure storage space;

FIG. 2 is a front perspective view of a known fixed, reach-in secure storage installation having a dual (left-right) sliding door entry into the secure storage space;

FIG. 3 is a front perspective view of a mobile, shelving unit according to the principles of the present invention incorporating a secure storage space and including dual locking sliding doors for accessing the secure storage space of the shelving unit;

FIG. 4 is a disassembled view of illustrating a mounting sleeve for supporting a shelf arranged on a corner post of the shelving unit, in accordance with the present disclosure;

FIG. 5 is a plan view of a shelf of the shelving unit supported on the corner post through the mounting sleeve, in accordance with the present disclosure;

FIG. 6 is a perspective view showing a rail mount assembly of a shelving unit incorporating a secure storage space and including dual locking sliding doors according to FIG. 3;

FIG. 7 shows an exploded perspective view of the rail mount assembly of FIG. 6;

FIG. 8 is a partial exploded perspective view showing a portion of the upper end of a shelving unit incorporating a secure storage space and including dual locking sliding doors according to FIG. 3;

FIG. 9 is a partial exploded perspective view detailing an upper support for dual locking sliding doors for a shelving unit incorporating a secure storage space and including dual sliding doors according to FIG. 3;

FIG. 10 is an enlarged, cross-sectional side view detailing an upper support for dual locking sliding doors for a shelving unit incorporating a secure storage space and including dual sliding doors according to FIG. 3;

FIG. 11 is an enlarged, cross-sectional side view detailing a lower support for dual sliding doors for a shelving unit incorporating a secure storage space and including dual locking sliding doors according to FIG. 3;

FIG. 12 is a perspective view of a portion of a shelving unit incorporating a secure storage space and including dual locking sliding doors according to FIG. 3 showing a latch assembly in a locked condition;

FIG. 13 is a perspective view showing a portion of a shelving unit incorporating a secure storage space and including dual locking sliding doors according to FIG. 3 showing a latch assembly in an unlocked condition;

FIG. 14 is an exploded perspective view showing a latch assembly for the shelving unit incorporating a secure storage space and including dual locking sliding doors according to FIG. 3;

FIG. 15 is a rear perspective view showing the latch assembly in a locked condition and with a back plate of the latch assembly removed for clarity;

FIG. 16 is a front perspective view showing the latch assembly of FIG. 15;

FIG. 17 is a perspective view of a front lower corner post and mounting sleeve of the shelving unit, in accordance with an aspect of the present disclosure;

FIG. 18A depicts a disassembled view of the mounting sleeve of FIG. 17, in accordance with the present disclosure; and

FIG. 18B depicts the mounting sleeve of FIG. 18A positioned on the corner post, in accordance with the present disclosure.

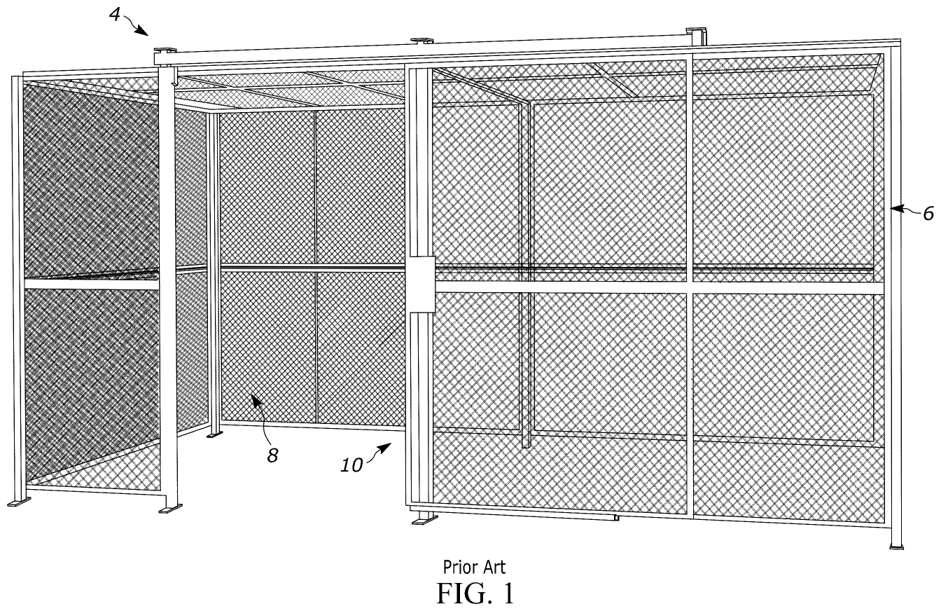

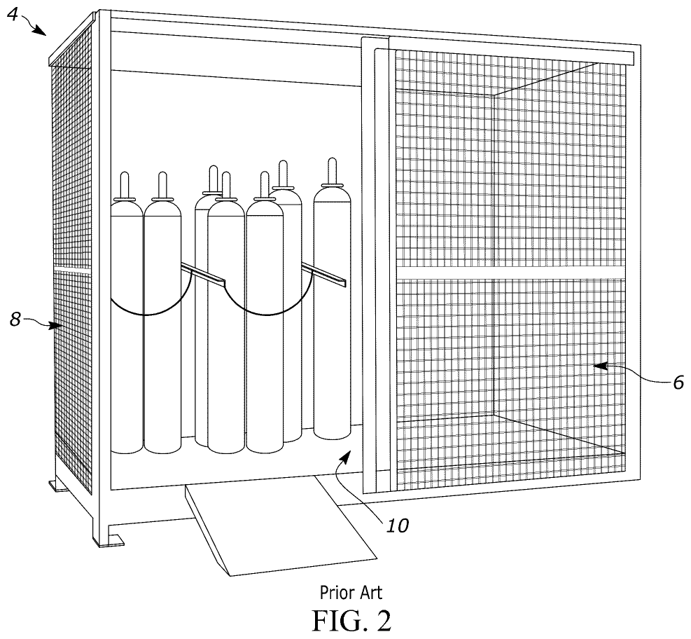

Corresponding reference numerals indicate corresponding parts throughout the several views of the drawings.

### DETAILED DESCRIPTION

Example embodiments will now be described more fully with reference to the accompanying drawings. The example embodiments are provided so that this disclosure will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The present disclosure provides a modular shelving unit incorporating a secure storage space having a side-by-side lockable sliding door arrangement for providing access to the secure storage space. The modular shelving unit having a secure storage space is also understood to persons skilled in the art as a security cage cart.

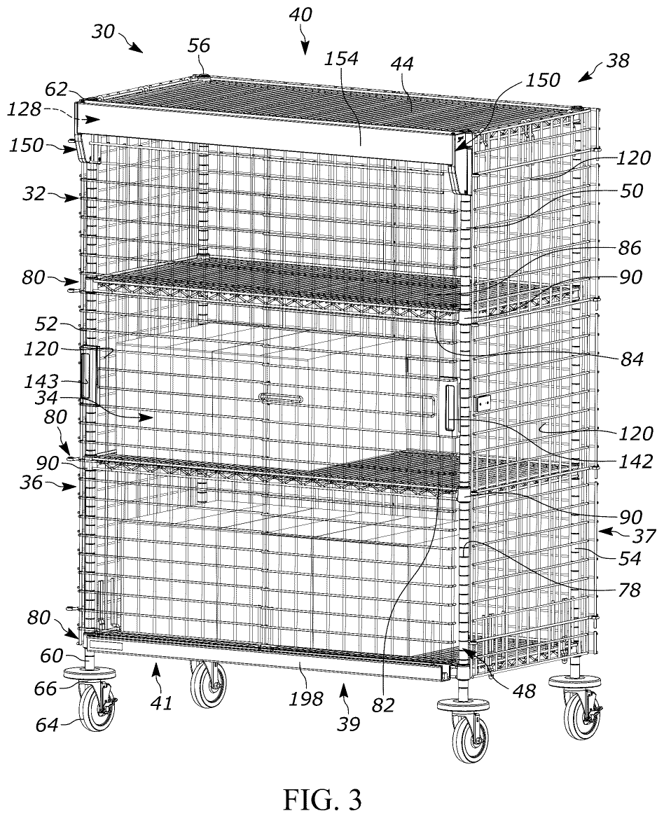

Turning now to the drawings, and particularly to FIGS. 3 through 9, a modular shelving unit 30 incorporating a secure storage space having a side-by-side lockable sliding doors 32 for providing access to a secure storage space 34 according to the principles and teachings of the disclosure is illustrated. The shelving unit 30 includes a first lateral side 36, a second lateral side 37, a rear side 38 and a front side 39, a top side 40 and a bottom side 41 that define secure storage space 34. FIG. 3 illustrates a security cage cart 42 embodied in a four-shelf mobile wire shelving unit 44, where the entirety of the internal storage space of the unit (i.e., excluding the top of the upper shelf) comprises the secure storage space 34. The shelving unit 30 can comprise a well-known industrial heavy gauge wire shelving units readily available from InterMetro Industries Corporation, Applicant and assignee of the present application, e.g., under the trademarks SUPER ERECTA® and EZ-Add™. Of course, other types of shelving units, the storage space of which is incorporated into a secure storage space of the unit, can have different shelving configurations, a different number of shelves, include vertical partitions dividing the storage space of the shelf or shelves, are contemplated and do not depart from the principles of the disclosure, including for example, shelving units readily available from InterMetro Industries Corporation under the trademarks MetroMax Q® and quikSLOT™.

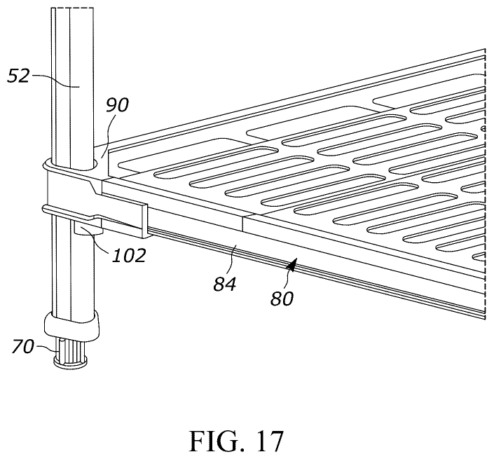

Referring to FIG. 3, a support structure 48 of the shelving unit 30 can include a plurality of elongated vertical support members or support posts, including a front right post 50, a front left post 52, a rear right post 54 and a rear left post 56. As is well understood and shown in the drawings, each support post 50, 52, 54, and 56 may be a cylindrically shaped column extending vertically along a longitudinal axis from a lower end to an upper end. Alternatively, the vertical support members or posts 50, 52, 54, and 56 may be columns having a polygonal-shaped cross-section or another cross-section. For example, as illustrated in FIG. 17, the vertical columns may be generally triangularly shaped in cross-section (e.g., so-called, tri-lobal posts) as shown in connection with front left post 52.

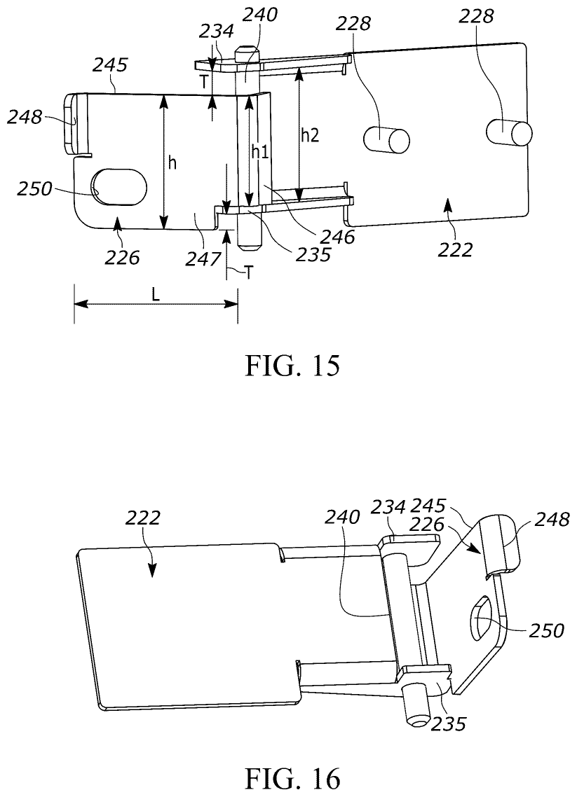

Each support post 50, 52, 54, and 56 includes a lower end, such as shown at 60, and an upper end such as shown at 62 in connection with left front support post 52. The lower end 60 of the support post 52 is operable to be positioned on and supported by a support surface (e.g., a floor). The lower end may include a small wheel 64 on a swivel 66, (e.g., a caster) making the shelving unit 30 mobile and easy to move. Alternatively, for a stationary shelving unit, the lower end 60 can include a cap or leveling foot such as shown at 70 in FIG. 17 to facilitate stability on the support surface. Alternatively, in some configurations, the lower end 60 may be positioned on and supported by a work surface, such as is disclosed in U.S. Patent Application Publication No. 2023/0028901, the disclosure of which is incorporated by reference (see e.g., FIG. 15 of the '901 publication).

Each support post 50, 52, 54, and 56 may include a plurality of annular grooves such as shown at 78 on front right support post 50 formed in the outer surface (not separately labeled) of the support post (e.g., in some cases, cylindrical grooves). The annular grooves 78 can be positioned along the longitudinal axis of the support post 50 from the lower end 60 to the upper end 62 with adjacent annular grooves 78 being vertically spaced apart from one another a predetermined distance (e.g., 1 inch). In some cases, annular grooves 78 on the outer surface of the support post 50 may be included on one or more sides of a post having a polygonal-shaped cross-section. At this point, while shown and described in connection with right front support post 50, each remaining support post 52, 54, and 56 may also include annular grooves.

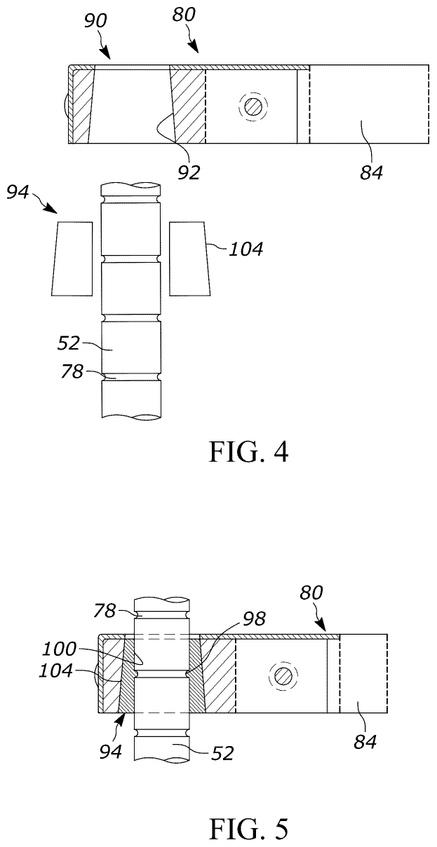

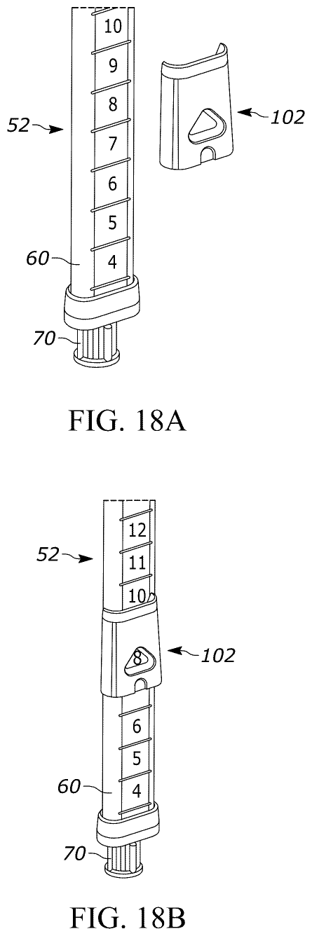

A plurality of shelves 80 having a well-known construction can also be included. For example, the shelves 80 may have a wire frame construction 82 (see, e.g., FIGS. 4-9) or be molded from a plastic (see, e.g., FIG. 17). Each shelf 80 generally includes a rectangular frame 84 and support surface 86 supported by and/or affixed to the frame 84. At each of the four corners (not separately labeled) of the shelf 80 is included an open, hollow, generally tube-like mounting collar 90 having a tapered inner surface 92 (e.g., a conically-tapered corner collar) that is integrated into the shelf frame 84 (e.g., by welding, molding or other attachment means). The support posts 50, 52, 54, and 56 in cooperation with the corner collars 90 of the shelves 80 enable the shelves 80 to be incorporated into the shelving unit 30. In this respect, the shelves 80 can be mounted to the support posts 50, 52, 54, and 56 in a manner similar to the shelves described in U.S. Pat. No. 3,424,111, the disclosure of which is incorporated by reference. Referring to FIGS. 4 and 5, mounting sleeves 94 (i.e., split sleeves or wedges) are configured to assemble onto the support posts 50, 52, 54, and 56. Each mounting sleeve 94 includes one or more inwardly protruding ribs 98 extending from an inner surface 100 of the mounting sleeve 94 (e.g., circumferential or semi-circumferential ribs). Alternatively, the mounting sleeve can be configured as shown at 102 in FIGS. 17, 18A, and 18B. When assembled onto a support post 50, 52, 54, and 56, the interior rib(s) 98 of the mounting sleeve 94 engages one or more annular grooves 78 in one of support posts 50, 52, 54, and 56 to fix the mounting sleeve 94 in a vertical location on the corresponding support post 50, 52, 54, and 56. The mounting sleeve 94 can have a conically-shaped or wedge-shaped exterior surface 104.

Inner tapered surface 92 of the hollow corner collars 90 is co-operable with the exterior surface 104 of the mounting sleeve 94. As such, the inner tapered surface 92 of each corner collars 90 can engage a corresponding exterior surfaces 104 of the mounting collars 94 along the longitudinal axis of the support posts 50, 52, 54, and 56 (i.e., in the vertical direction). The corresponding inner surfaces 92 of the corner collars 90 and outer surfaces 104 of the mounting sleeves 94 create a wedge fit between the collars 90 and sleeves 94 and simultaneously compress the sleeves 94 against corresponding ones of the posts 50, 52, 54, and 56. This configuration securely attaches the shelf 80 to the support posts 50, 52, 54, and 56. Even after the shelf 80 is attached to the support posts 50, 52, 54, and 56, the position of the shelf can be changed, for example, by repositioning the mounting sleeves 94 along the support posts 50, 52, 54, and 56. Further, the shelving unit 30 can be reconfigured by adding or removing shelves 80.

The shelves 80, themselves, can define upper and/or lower boundaries of the enclosed space 34. Additionally, the lateral sides 36 and 37 and the rear side 38 of the shelving unit 30 can be covered by panels 120 that define the enclosed space 34. In the drawings, the lateral sides 36 and 37 and rear side 38 of secure storage space 34 are shown to comprise heavy gauge, open wire framework panels (not separately labeled) as are well-known in the field, that are securely affixed, attached or fastened to the support posts 50, 52, 54, and 56 and/or the frames 84 of the shelves. Alternatively, the lateral sides 36 and 37 and rear side 30 of secure storage space 34 can comprise solid wall panels (not shown) made from e.g., a sheet material formed from a metal or a plastic material.

The front side 39 of the shelving unit 30 further includes sliding doors 32 and a sliding door mounting system 128 that complete the enclosure of the storage space 34 provided by the shelving unit 30 to create a security cage storage unit 42 according to the principles of the present disclosure. It should be noted, however, that it is contemplated that sliding doors 32 can be provided, in addition, on rear side 38 of the shelving unit 30 in place of a fixed rear panel(s) 120, to provide access to the enclosed space 34 from both sides 38 and 39 (e.g., rear and front) of the shelving unit 30.

As best seen in FIG. 3, the shelving unit 30 includes a plurality (e.g., two) sliding doors 32 positioned across the front side 39 of the shelving unit 30. The sliding doors 32 are movable laterally (e.g., slidable left and right) to open and close and provide or prohibit access to the storage space 34 of the shelving unit 30. The doors can comprise heavy gauge, open wire framework panels or solid wall panels, as previously described. While two side-by-side lockable sliding doors are illustrated (e.g., left and right side-by-side sliding doors), it can be readily understood that a greater number of side-by-side doors can be employed. Further, the sliding doors 32 are shown to be configured to enclose the entire height and width of the shelving unit 30 (e.g., the storage space 34 provided by all of the shelves). It is contemplated, however, that the security cage storage unit 30 can provide an enclosed storage space 34 (i.e., bounded by side and rear panels and sliding doors) that can be less than the total storage space provided by the entire shelving unit 30. More particularly, for example, the secure storage space 34 can encompass the storage space provided by only one or two of the shelves 80. Further, it is contemplated that, with the use of vertical shelf dividers (not shown) and by employing a single sliding door(s) side-by-side with a fixed panel(s), the enclosed storage space 34 can encompass the storage space of only a portion of a shelf(ves) 80.

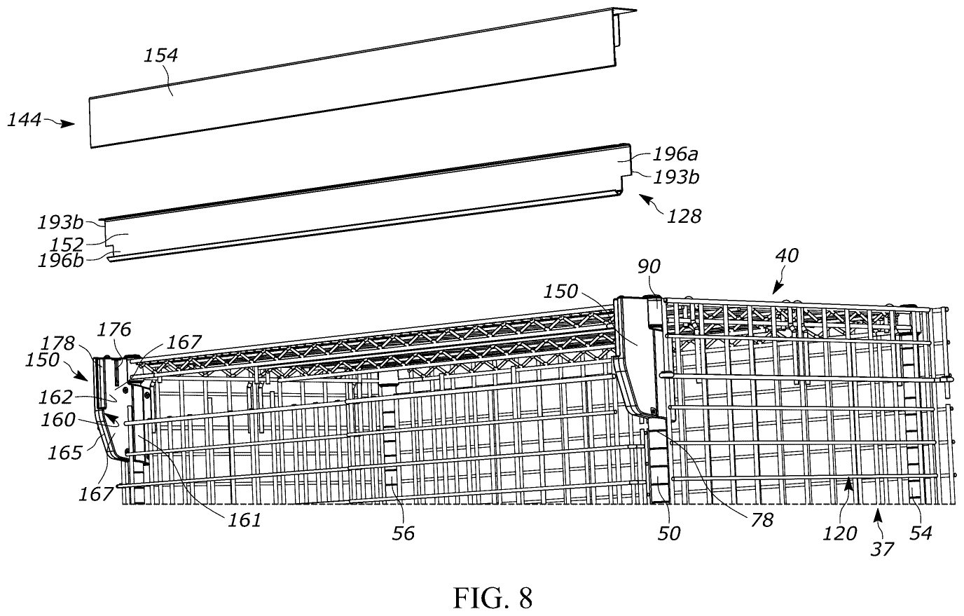

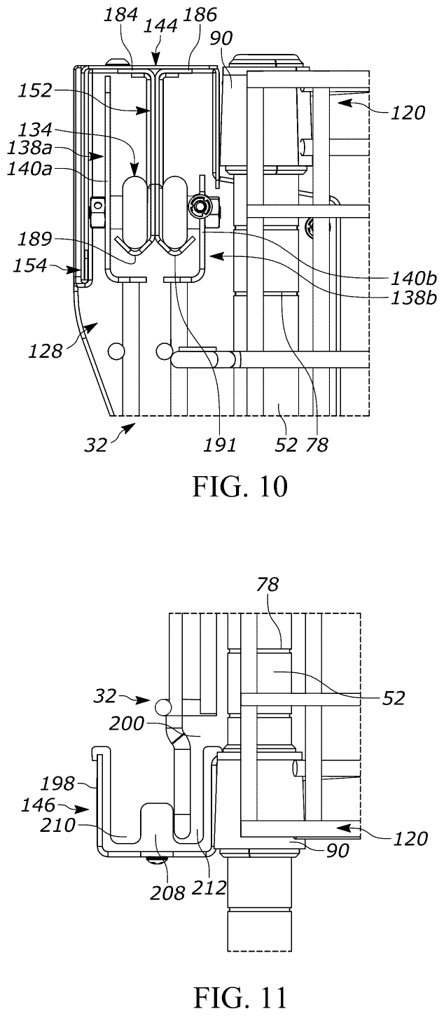

Referring to FIG. 10, an upper end of each of the sliding doors 32 is configured with one or more rollers or wheels 134 that allow for smooth and easy opening and closing of the doors 32. Specifically, each door 32 is shown to include an L-shaped bracket 138a and 138b attached to the upper end of the door panel and including an upwardly extending leg 140a and 140b respectively. The rollers 134 can be attached to the leg 140a, 140b, of each bracket 138a, 138b as illustrated so that a bearing surface of the rollers 134 is spaced above the door panel. Also as shown in FIG. 8, the lateral side-by-side lockable sliding doors 32 are spaced apart, one in front of the other, with the rollers 134 of each door 32 in an inwardly opposing orientation, as is further discussed herein.

The sliding doors 32 can also include low-profile door handles 142 and 143 that promote the easy operation of the sliding doors 32. Each handle 142, 143 can be attached to the door panel at a location that enables the handle 142, 143 to be used regardless of the position of any of the doors 32, from fully open to fully closed.

The sliding door mounting system 128 generally includes a top or upper door support 144 (FIG. 10) and a lower or bottom door rail or channel 146 as shown in FIG. 11.

As best seen in FIGS. 8, 9 and 10, the top door support includes a plurality (e.g., 2) of rail mounts 150, each attached to a support post 50 and 52 of the shelving unit 30, a slide rail 152 attached to and/or supported by the rail mounts 150, and an upper fascia or cover 154 attached to and/or supported by the rail mounts 150 and the slide rail 152.

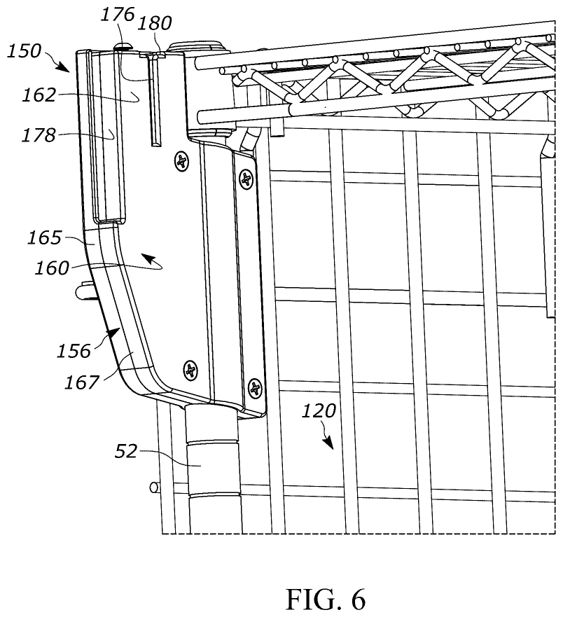

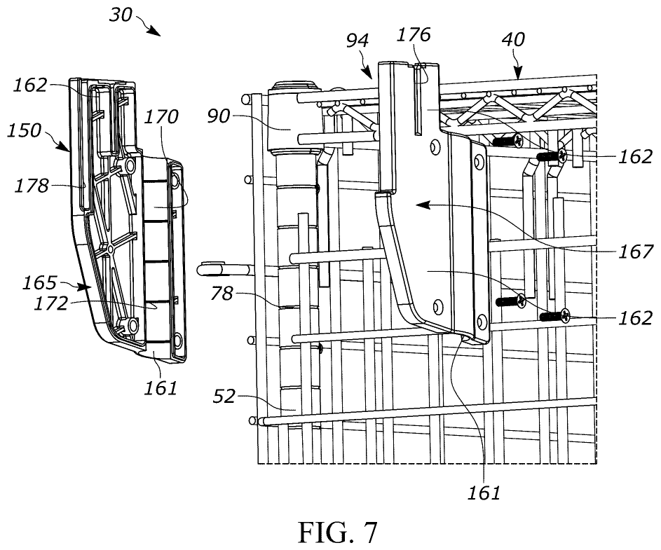

The rail mounts 150 can be understood with reference to FIGS. 6 and 7. Each of the rail mounts 150 can be defined by a body including a post mount portion 94 and a support portion 162. The body 160 can comprise a two-piece construction including a first or outer rail mount body half 165 and second or inner rail mount body half 167. Alternatively, the rail mount body halves can be mirror images of one another. As can be understood from FIG. 7, the two halves can be joined together by fasteners in a clamshell arrangement to surround and attach to a support post 50, 52. More particularly, the post mount portion 94 of the rail mounts 150 is configured to assemble onto the support posts 50, 52 in a manner similar to the mounting sleeves 94 for the shelves as already discussed. In this respect, a cylindrical interior surface 170 of the post mount portion 161 includes a plurality of ribs 172 protruding from the interior surface and toward a longitudinal centerline of the post mount portion 161 as shown in FIG. 7. When the first and second rail mount body halves 165, 167 are assembled and fastened onto the support post 52, the ribs 172 engage one or more of the annular grooves 78 in the support post 52 and fix the rail mount 150 in a vertical location on the support post 52.

The support portion 162 of the rail mount 150 can include a slide rail support slot 176 and a support recess. The slide rail support slot 176 provides a narrow opening at an upper end of the rail mount 150 about midway between a front side and a rear side of the support portion 162. The support slot 176 is narrow and extends downward into the support portion 162 for a distance. Also, a shallow recess 180 can be provided at the upper end of the rail mount 150 around the opening of the support slot 176. The support slot 176 and shallow recess 180 are configured to receive and accommodate the slide rail 152 as further discussed herein.

Also included along the front side and top side of the support portion of the rail mount is support recess or groove 178 configured to receive the upper fascia 154. A depth of the recess or groove 178 is sized so that the fascia 154 can sit flush with the rail mount 150 to present an aesthetically pleasing finished appearance for the shelving unit 30.

The slide rail 152 is best understood with reference to FIGS. 8, 9 and 10. The slide rail 152 is configured so that the sliding doors 32 can hang from the slide rail 152 and the sliding doors 32 can move along the slide rail 152 to open and close. The slide rail 152 extends for a length along its longitudinal axis. The length of the slide rail 152 correlates to the width of the secure storage space 34 (e.g., the width of the shelves and/or shelving unit). The slide rail 152 is configured to be supported at each of its opposite longitudinal ends by a rail mount 150.

As shown in FIG. 10, in cross-section, the slide rail 152 can be generally understood as defining two open C-channels arranged back-to-back, with a first, forward-open facing C-channel 184 (e.g., an outer channel) and a second, rearward-open facing C-channel 186 (e.g., an inner channel). At an upper end of the slide rail 152, the back-to-back C-channel configuration defines a T-shape of the slide rail 152 (as seen in cross-section). The lower end of the slide rail defines, respectively, a front (outer) roller track 189 and a rear (inner) roller track 191. Each of the front and rear roller track 189, 191 is configured to receive and accommodate the roller(s) 134 attached to a sliding door 32. As such, the side-by-side lockable sliding doors 32 are arranged such that the doors 32 are, respectively, forward and rearward relative to one another (e.g., outer and inner). As can be understood, this configuration enables each door 32 to laterally slide in its respective track 189, 191 and past the other door, as either or both of the doors are opened and closed.

As seen in FIG. 8, the opposite longitudinal ends 193a and 193b of the slide rail 152 are notched to define extension portions 196a and 96b respectively. The extension portions 196a and 196b are sized to be snugly received in the slide rail support slots 176 of the rail mounts 150 (e.g., from above, as shown by the arrows in FIG. 8). When attached to the rail mounts 150, the T-shaped upper end of the slide rail 152 can be received in the shallow recess 180 such that it is flush with the upper end of the rail mount 150.

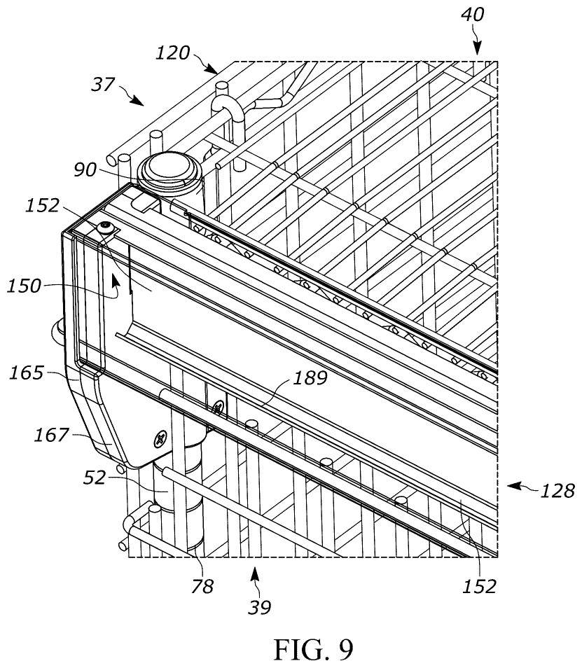

As shown in FIGS. 3, 9 and 10, the upper fascia 154 provides an aesthetically pleasing finish cover for the upper door support 144. The upper fascia 154 can define a front and top of the upper door support 144, generally covering the slide rail 152, roller track 189 and door rollers 134. The fascia 154 extends longitudinally for a length that correlates to the width of the secure storage space 34 (e.g., the width of the shelves and/or shelving unit). The respective longitudinal ends of the fascia 154 can be received in the support recess 178 of the rail mount 150 located along the front side and top side of the support portion 162 of the rail mount 150. As best seen in FIGS. 3 and 9, the upper fascia 154 can sit flush with the rail mount 150 and/or otherwise present an aesthetically pleasing finished appearance for the shelving unit 30. Additionally, the securely attached upper fascia 154 provides an obstacle to prevent unauthorized removal of the sliding doors 32 from the shelving unit. For example, the upper fascia 154 can interfere with the L-shaped brackets 138a and 138b attached to the upper ends of the door panels to limit or prevent lifting and/or tilting the sliding doors 32 and/or separating the rollers 134 from the roller tracks 189, 191 of the slide rail 152. As such, the upper fascia 154 can prohibit the sliding doors 32 from being removed.

As best seen in FIG. 11, the bottom door channel 146 includes a lower fascia or cover 198 attached to a front frame 200 of a lower shelf 80 of the shelving unit 30 and a guide 208 disposed within and supported by and/or attached to the lower fascia 198. Similar to the upper fascia 154, the lower fascia 198 provides a neat, clean and aesthetically pleasing outer appearance to the bottom door channel 146.

The guide 208 captures the lower ends of the sliding doors 32 and retains the sliding doors 32 thereby preventing access to the secure storage space 34 from the bottoms of the doors 32. The guide 208 also helps to promote the smooth and easy opening and closing of the doors 32. The guide 208 defines forward (outer) 210 and rearward (inner) guide channels 212, each of which receives and secures a respective one of the sliding doors 32 (i.e., the forward positioned door in the forward guide channel and the rearward positioned door in the rearward guide channel). The guide 208 can be made from a durable, resilient, low friction material, such as a plastic.

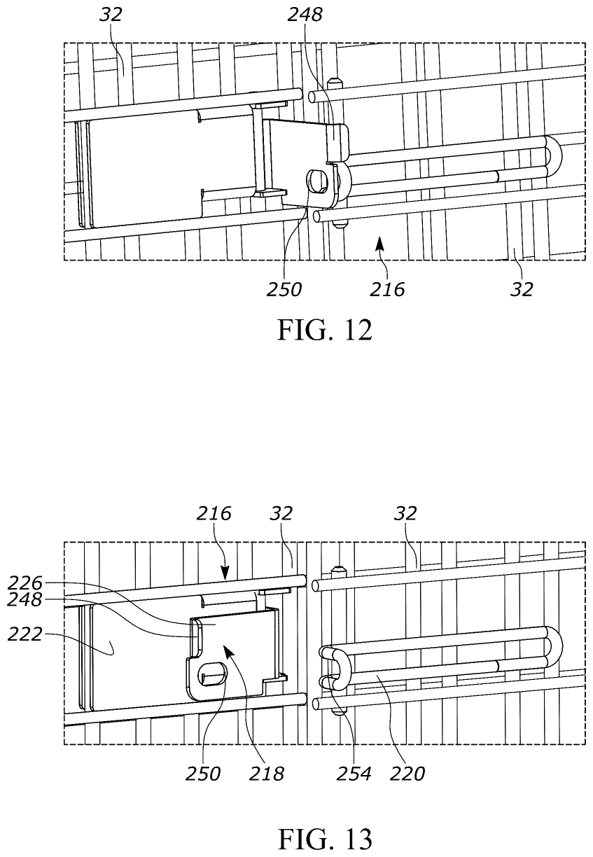

With reference to FIGS. 12 and 13, a door latching mechanism 216 is shown. The door latching mechanism 216 provides a locked and an unlocked position for both sliding doors 32. In the locked position, both doors 32 are secured closed and cannot open, independent of whether a padlock is also used. In the unlocked position, both doors 32 are free to move between the opened and closed positions.

The door latching mechanism 216 comprises a latch assembly 218 secured to one of the sliding doors 32 and a wire loop 220 secured to the other of the sliding doors 32. The latch assembly 218 and the wire loop 220 cooperate to lock and unlock the sliding doors 32.

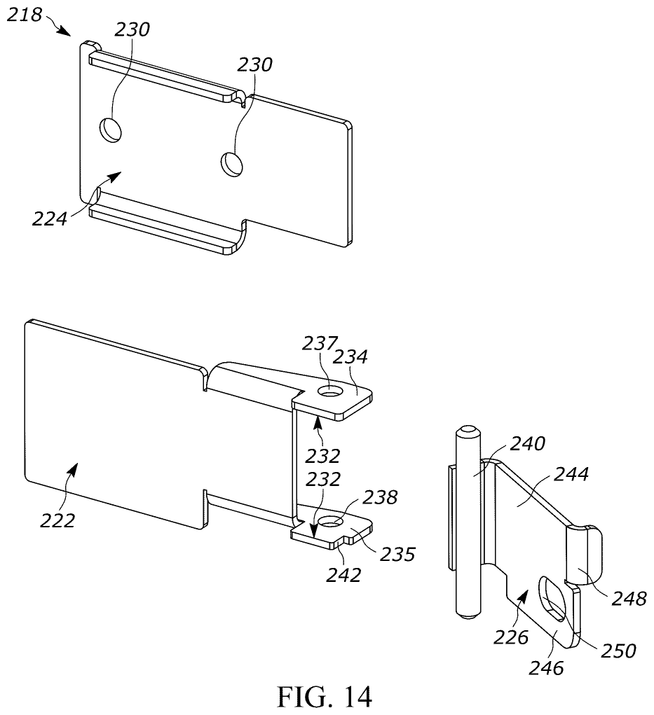

Turning now to FIGS. 14, 15 and 16, the latch assembly 218 is shown in greater detail. The latch assembly 218 generally includes a hinge plate 222, a back plate 224 and a pivot latch 226. The hinge plate 222 and back plate 224 secure the latch assembly 218 to the sliding door 32. The pivot latch 226 is pivotably attached to the hinge plate 222. The hinge plate 222 is disposed on a front side of the sliding door 32 and can include threaded mounting posts 228. The back plate 224 is disposed on the back side of the sliding door and can include mounting apertures 230 that align with and receive the mounting posts 228 of the hinge plate. The mounting posts 228 of the hinge plate 222 can pass through the wire frame of the sliding door 32 and into and through the mounting apertures 230 of the back plate 224. Threaded nuts (not shown) can capture and secure the back plate 224 to the hinge plate 222, sandwiching the sliding door 32 between the hinge plate 222 and the back plate 224. Alternatively, the latch assembly 218 can be attached to the sliding door 32 by other fastening means, e.g., by welding.

The pivot latch 226 is pivotably attached to the hinge plate 222 and is operable to rotate about a pivot axis between a first or locked position and a second or unlocked position. Referring back to FIGS. 14-16, the hinge plate 222 includes a yoke bracket 232 having upper 234 and lower 235 horizontally opposed flanges. Each of the opposed flanges 234, 235 includes a corresponding pivot aperture 237, 238 extending through the respective flange 234, 235. The pivot apertures 237, 238 are vertically aligned and centered on a vertical axis (i.e., a pivot axis). The pivot latch 226 includes a pivot bar 240 that is received in the pivot apertures, as discussed further herein.

The lower flange 235 of the yoke bracket 232 includes a corner notch or cutout 242 that defines a first or forward ledge and a second or side ledge of the lower flange 235. The forward ledge and the side ledge each extend outward from the vertical axis. A first perimeter wall of the forward ledge and a second perimeter wall of the side ledge can intersect at approximately 90 degrees and define the boundaries of the corner notch.

The pivot latch 226 generally includes a latch plate 244 and the pivot bar 240. The latch plate 244 can be a flat plate formed into or having an L-shape, with a first leg 245 and a second leg 246. The first leg 245 can have a length L and a height H and the second leg can have a length l and a height h1, and the respective dimensions can be H>h1 and L>l. The first and second legs of the latch plate 226 can be joined together at their respective proximal ends and extend from one another toward their respective distal ends, creating an included angle between the first and second legs. The included angle can be, e.g., 90 degrees or another suitable angle.

Referring to FIGS. 14 and 15, the latch plate 226 can include a locking shoulder 247 located at a lower side of the proximal end of the latch plate 226. The locking shoulder 247 can be defined so that at the locking shoulder 247 the height H of the first leg is equal to the height h1 of the second leg. The locking shoulder 247 of the latch plate 226 is co-operable with the corner notch of the lower flange 235 of the yoke bracket 232 to fix the pivot latch 226 in a locking position, as further discussed herein.

The latch plate 226 can also include a tab 248 at the distal end of the longer first leg. The tab 248 can extend generally outward or orthogonally to the first leg and provides a feature of the pivot latch 226 able to be grasped by a user to manipulate the pivot latch. Also, near the distal end of the longer first leg of the latch plate is a locking aperture 250. In the locked condition of the locking mechanism 218, the locking aperture 250 of the pivot latch 226 can align with an annular opening 254 through the wire loop. A padlock or similar device can be attached to the locking mechanism 218 through the aligned openings to further secure the storage space.

The pivot bar 240 can be a rod or cylinder that has an outer dimension (e.g., a diameter) and extends for a length along a central longitudinal axis. The pivot bar 240 is attached to and along the shorter second leg of the latch plate 222 at or near the distal end of the second leg. The outer dimension of the pivot bar 240 (e.g., the outer diameter) can be smaller than the inner dimension of the pivot apertures 237, 238 (e.g., the inner diameter) of the horizontally opposing flanges 234, 235 of the yoke bracket 232. The length of the pivot bar 240 is greater than the distance between the horizontally opposing flanges 234. 235 of the yoke bracket 232. Assembled, the pivot latch 226 is attached to the hinge plate 222 such that the central longitudinal axis of the pivot bar 240 is generally coincident with the vertical axis and opposite ends of the pivot are received, respectively, in the pivot apertures 237, 238 and extend beyond the opposing flanges 234, 235. In this manner, the pivot latch can pivot or rotate relative to the yoke bracket and hinge plate.

With particular reference to FIG. 15, the opposing flanges 234, 235 are spaced apart a distance h2, which is greater than the height h1 of the second leg 246 of the latch plate 226. Further, the pivot bar 240 extends along the vertical axis beyond the lower flange 235 of the yoke bracket 232 a distance T, which is greater than a distance t between the second leg 246 of the latch plate 226 and the upper flange 234 of the yoke bracket 232. Thus, the pivot latch 226 can also move vertically between the upper and lower flanges 234, 235 of the yoke bracket 232, in addition to being able to pivot or rotate.

FIGS. 12 and 13 show the latch mechanism 218, respectively, in a locked condition and an unlocked condition. As shown in FIG. 10, in the locked condition, the first leg 245 of the latch plate 244 of the pivot latch 226 projects outward and generally orthogonal to the hinge plate 222 (i.e., generally orthogonal to the sliding door 32) and the lock aperture 250 of the latch plate 244 is generally aligned with the opening 254 through the wire loop 220. In the locked condition, movement of the sliding doors 32 is prevented by the interference between the pivot latch 244 and the wire loop 220. More specifically, as depicted in FIG. 12, the right, outer sliding door 32 is in the closed position and can only move toward the open position by sliding the door 32 to the left (see arrow). The left, inner sliding door 32 is in the closed position and can only move toward the open position by sliding the door to the right (see arrow). Opening the right sliding door 32, however, is prohibited by the wire loop 220 (attached to the right sliding door) abutting and being obstructed from movement by the pivot latch 244, and opening the left sliding door 32 is prohibited by the pivot latch 244 (attached to the left sliding door) abutting and being obstructed by the wire loop 220.

As illustrated in FIG. 13, in the unlocked condition, the first leg 245 of the latch plate 244 is generally parallel to the hinge plate 222 and the tab 248 projects outward and generally orthogonal to the hinge plate 222 and sliding door 32. The pivot latch of the locking assembly does not align with the wire loop, but instead is adjacent to the hinge plate. As can be understood from FIG. 11, in the unlocked condition, the left and right sliding doors are free to slide back and forth without obstruction.

Operation of the latch mechanism 218 can be understood as follows. From the unlocked condition, the pivot latch 226 is pivoted in a first direction (i.e., outward and away from the hinge plate. At a predetermined pivotal travel of the pivot latch 226 (e.g., 90 degrees), the pivot latch 226 can move into a locking position. In the locking position, the locking shoulder 247 of the latch plate 244 can be vertically aligned with the corner notch 242 of the lower flange 235 of the yoke bracket 232. Upon such an alignment, the pivot latch 226 can then move vertically downward between the opposing upper and lower flanges 234, 235 of the yoke bracket 232 so that the locking shoulder 247 is received in or nested with the corner notch 242. In the locking position of the pivot latch, pivotal movement of the pivot latch 226 in a second direction opposite to the first direction (i.e., inward and toward the hinge plate) is obstructed by interference of the corner notch 242 (i.e., the first perimeter wall of the forward ledge) with the latch plate 244. Consequently, the pivot latch 226 becomes fixed in the position (i.e., projecting outward and generally orthogonal to the hinge plate) that obstructs opening the sliding doors 32.

From the locking position, to unlock the sliding doors 32 movement of the pivot latch 226 is reversed. First the pivot latch 226 is moved vertically upward between the opposing upper and lower flanges 234 and 235 so that the locking shoulder 247 is no longer received in or nested with the corner notch 242. Thereafter, the pivot latch 226 is free and can be rotated toward the hinge plate 222 (as shown in FIG. 13) to unlock the locking mechanism 218.

While the drawings show a security cage cart 30 embodied in a three shelf mobile wire shelving unit, where the entirety of the storage space 34 of the unit (i.e., all three shelves) comprises the secure storage space, it can be readily understood that the apparatus of the present disclosure can be implemented in other configurations and in other types of storage apparatus. For example, the secure storage space can be limited to lesser than all of the storage shelves (e.g., only one or two of the storage shelves). Also, a greater or fewer number of storage shelves can be included. Further, the shelving unit need not be mobile, but can be a stationary shelving unit. Still further, the shelving unit need not comprise a wire rack or have standard wire shelving. Other modifications to the apparatus of the present disclosure may be made without departing from the principles or teachings of the disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A shelving unit including a secure storage space and at least one lockable sliding door for providing access to the secure storage space, the shelving unit comprising:
a support structure comprising a plurality of elongated vertical support posts, including a front right support post, a front left support post, a rear right support post and a rear left support post;
wherein each elongated vertical support post comprises a column extending a vertical length along a vertical longitudinal axis from a lower end to an upper end;
wherein the lower end is operable to be positioned on and supported by a support surface and comprises one of a leveling foot and a wheel on a swivel;
wherein each support post includes a plurality of grooves formed in an outer surface of the elongated vertical support post, the grooves being positioned along the vertical longitudinal axis of the elongated vertical support post from the lower end to the upper end with adjacent grooves being vertically spaced apart from one another at a predetermined distance;
a plurality of shelves selectively supported by the plurality of elongated vertical support posts, each of the plurality of shelves comprising a rectangular frame and a support surface affixed to the rectangular frame;
wherein each rectangular frame comprises four collars, each collar located a corner of the rectangular frame, wherein each collar of the four collars comprises an open, generally tube-like structure having a tapered inner surface;
a plurality of mounting sleeves, wherein each mounting sleeve comprises an inner surface including a rib and a tapered exterior surface, wherein the rib of each mounting sleeve is configured to engage a first groove of the plurality of grooves formed in the outer surface of each of the plurality of elongated vertical support posts;
wherein the plurality of mounting sleeves in cooperation with the collars of the shelves enable the shelves to be incorporated into the shelving unit at various vertical heights along the vertical lengths of the plurality of vertically elongated support posts;
wherein the secure storage space of the shelving unit is defined by a right side enclosure, a left side enclosure and a rear enclosure, wherein each of the right side enclosure, the left side enclosure, and the rear enclosure comprises a panel securely attached to at least one of the support structure and the rectangular frame of a respective one of the plurality of shelves;
wherein the secure storage space is further defined by a first shelf of the plurality of shelves defining an upper enclosure and a second shelf of the plurality of shelves defining a lower enclosure;
wherein the secure storage space is further defined by a sliding door assembly defining a front enclosure;
wherein the sliding door assembly comprises a plurality of side-by-side lockable sliding doors and a sliding door mounting system positioned across a front of the shelving unit;
wherein an upper end of each of the plurality of side-by-side lockable sliding doors comprises one or more rollers that allow for smooth and easy opening and closing of a corresponding one of the plurality of side-by-side lockable sliding doors;
wherein each sliding door of the plurality of side-by-side lockable sliding doors comprises a low-profile door handle attached to the corresponding one of the side-by-side lockable sliding doors and enabling the low-profile door handle to be accessed independent of the position of any of the plurality of side-by-side lockable sliding doors, from a fully open position to a fully closed position;
wherein the sliding door mounting system comprises an upper door support and a bottom door rail;
wherein the upper door support comprises a plurality of rail mounts, each rail mount of the plurality of rail mounts being attached to one of the plurality of vertically elongated support posts of the shelving unit, a slide rail supported between two of the plurality of rail mounts, and an upper fascia supported between the two of the plurality of rail mounts and the slide rail;
wherein each of the plurality of rail mounts is defined by a body including a post mount portion and a support portion;
wherein the post mount portion of each of the plurality of rail mounts comprises an inner surface having at least one second rib, wherein the second rib of each of the plurality of rail mounts is configured to engage a second groove of the plurality of grooves formed in the outer surface of each of the plurality of elongated vertical support posts;
wherein the support portion of each of the plurality of rail mounts comprises a slide rail support slot and a support recess;
wherein the slide rail support slot provides a narrow opening at an upper end of each of the plurality of rail mounts about mid-way between a front side of the support portion and a rear side of the support portion;
wherein the slide rail support slot extends vertically downward into the support portion for a selected distance;
wherein the upper end of each of the plurality of rail mounts includes a shallow recess arranged adjacent to the narrow opening of the slide rail support slot, the shallow recess being configured to accommodate an upper end of the slide rail;
wherein a front side and a top side of the support portion of each of the plurality of rail mounts comprises a support recess configured to receive the upper fascia, wherein a depth of the support recess is sized so that the upper fascia can sit flush with the upper end of the corresponding one of the plurality of rail mounts;
wherein the slide rail extends for a horizontal length along a horizontal longitudinal axis;
wherein the horizontal length the slide rail correlates to a width of the secure storage space;
wherein the slide rail is configured to be supported at each of its opposite horizontal longitudinal ends by a respective one of the plurality of rail mounts;
wherein the slide rail is configured so that each sliding door of the plurality of side-by-side lockable sliding doors can hang from the slide rail and move between the fully open position and the fully closed position;
wherein the slide rail is defined by two open C-channels arranged back-to-back, the two open C-channels including a first, forward-open facing C-channel and a second, rearward-open facing C-channel;
wherein an upper end of the slide rail defines a cross-sectional T-shape, and a lower end of the slide rail defines a front roller track and a rear roller track;
wherein each of the front roller track and the rear roller track is configured to receive and accommodate the one or more rollers attached to a respective one of the plurality of side-by-side lockable sliding doors, such that the plurality of side-by-side lockable sliding doors includes a forward sliding door and a rearward sliding door;
wherein each of the plurality of side-by-side lockable sliding doors is operable to laterally slide in a respective one of the front roller track and rear roller track and past the other of the plurality of side-by-side lockable sliding doors, as either or both of the plurality of side-by-side lockable sliding doors is transitioned between the fully open position and the fully closed position;
wherein opposite longitudinal ends of the slide rail are notched to define extension portions;
wherein the extension portions are sized to be snugly received in the slide rail support slots of corresponding ones of the plurality of rail mounts;
wherein the upper end of the slide rail is received in the shallow recess such that it is flush with the upper end of the corresponding one of the plurality of rail mounts;
wherein the upper fascia defines a front and a top of the upper door support, covering the slide rail, the front roller track, the rear roller track and the one or more rollers on each of the plurality of side-by-side sliding doors;
wherein the upper fascia extends longitudinally for a second horizontal length that correlates to the width of the secure storage space;
wherein respective longitudinal ends of the upper fascia are each received in the support recess of a respective one of the plurality of rail mounts;
wherein the bottom door rail comprises a lower fascia attached to a front frame of the second shelf of the shelving unit and a guide disposed within and supported by the lower fascia;
wherein the guide captures and retains a lower end of the each of the plurality of side-by side sliding doors and is configured to substantially prevent movement of the lower end of each of the plurality of side-by-side lockable sliding doors in a first direction orthogonal to a longitudinal extent of the guide and simultaneously provide a smooth and easy opening and closing of the plurality of side-by-side lockable sliding doors in a second direction along the longitudinal extent of the guide;
wherein the guide defines a forward guide channel and a rearward guide channel, wherein each of the forward guide channel and the rearward guide channel receives and accommodates a respective lower end of one of the plurality of side-by-side sliding doors;
a latch assembly for providing a locked condition and an unlocked condition for each of the plurality of side-by-side lockable sliding doors, the latch assembly comprising.
a hinge plate, a back plate, and a pivot latch;
wherein the hinge plate and back plate secure the latch assembly to a first door of the plurality of side-by-side lockable sliding doors; and
wherein the pivot latch is pivotably attached to the hinge plate and is operable to rotate about a pivot axis between the locked condition and the unlocked condition.

2. A shelving unit including a secure storage space, the shelving unit comprising:
a support structure having a plurality of elongated vertical support posts, including a front right support post, a front left support post, a rear right support post and a rear left support post;
wherein each elongated vertical support post comprises a column extending vertically for a length along a vertical longitudinal axis from a lower end to an upper end;
wherein the lower end is operable to be positioned on and supported by a support surface;
a plurality of shelves selectively connected to each of the plurality of elongated vertical support posts, each of the plurality of shelves comprising a frame and a support surface affixed to the frame;
a right side enclosure, a left side enclosure and a rear enclosure, wherein each of the right side enclosure and the left side enclosure comprises a panel securely attached to the shelving unit at one of the support structure and a frame of one of the plurality of shelves;
an upper enclosure defined by a first shelf of the plurality of shelves and a lower enclosure defined by a second shelf of the plurality of shelves; and
a front enclosure comprising a sliding door assembly, wherein the sliding door assembly comprises a plurality of side-by-side lockable sliding doors and a sliding door mounting system positioned across a front of the shelving unit.

3. The shelving unit according to claim 2, wherein each of the right side enclosure, the left side enclosure, and rear enclosure are fixedly connected to the frame of each of the first shelf of the plurality of shelves and the second shelf of the plurality of shelves.

4. The shelving unit according to claim 2, wherein an upper end of each of the plurality of side-by-side lockable sliding doors comprises one or more rollers that allow for opening and closing of a corresponding one of the plurality of side-by-side lockable sliding doors between an open position and a closed position.

5. The shelving unit according to claim 4, wherein each sliding door of the plurality of side-by-side lockable sliding doors comprises a low-profile door handle that is accessible independent of a position of any of the plurality of side-by-side lockable sliding doors, from a fully open position to a fully closed position.

6. The shelving unit according to claim 4, wherein the sliding door mounting system comprises an upper door support and a bottom door rail.

7. The shelving unit according to claim 6, wherein the upper door support comprises a plurality of rail mounts, each rail mount of the plurality of rail mounts being attached to one of the plurality of vertically elongated support posts.

8. The shelving unit according to claim 7, wherein the upper door support includes a slide rail supported between two of the plurality of rail mounts, and an upper fascia supported between the two of the plurality of rail mounts and the slide rail.

9. The shelving unit according to claim 8, wherein each of the plurality of rail mounts is defined by a body including a post mount portion and a support portion.

10. The shelving unit according to claim 9, wherein the support portion of each of the plurality of rail mounts comprises a slide rail support slot and a support recess, the slide rail being received by the slide rail support slot and the upper fascia being received by the support recess.

11. The shelving unit according to claim 10, wherein the slide rail is defined by two open C-channels arranged back-to-back, the two open C-channels including a first, forward-open facing C-channel and a second, rearward-open facing C-channel.

12. The shelving unit according to claim 11, wherein an upper end of the slide rail defines a cross-sectional T-shape, and a lower end of the slide rail defines a front roller track and a rear roller track.

13. The shelving unit according to claim 6, wherein the bottom door rail comprises a lower fascia attached to a front frame of the second shelf of the shelving unit and a guide disposed within and supported by the lower fascia.

14. The shelving unit according to claim 13, wherein the guide captures and retains a lower end of the each of the plurality of side-by side sliding doors and is configured to substantially prevent movement of the lower end of each of the plurality of side-by-side lockable sliding doors in a first direction orthogonal to a longitudinal extent of the guide and simultaneously provide a smooth and easy opening and closing of the plurality of side-by-side lockable sliding doors in a second direction along the longitudinal extent of the guide.

15. The shelving unit according to claim 2, wherein each elongated vertical support post includes a lower end, an upper end, outer surface extending between the lower end and the upper end, and a plurality of grooves formed in the outer surface, the plurality of grooves being arranged between the lower end and the upper end with adjacent grooves being vertically spaced apart from one another at a predetermined distance; and
further comprising a plurality of mounting sleeves arranged along each of the plurality of elongated vertical support posts, each of the plurality of mounting sleeves engaging one of the plurality of grooves on a corresponding one of the plurality of elongated vertical support posts; and
wherein each of the plurality of shelves includes four collars, each collar of the four collars being located a corner of the frame and includes an open, generally tube-like structure having a tapered inner surface receptive of one of the plurality of mounting sleeves.

16. The shelving unit according to claim 2 wherein the rear enclosure comprises a second sliding door assembly comprising a second plurality of side-by-side lockable sliding doors and a second sliding door mounting system positioned across a rear of the shelving unit.

17. A door latch assembly for providing a locked condition and an unlocked condition for each door of a pair of side-by-side sliding doors, the door latching assembly comprising:
a hinge plate, a back plate and a pivot latch;
wherein the hinge plate and back plate secure the door latch assembly to a first door of the pair of side-by-side sliding doors; and
wherein the pivot latch is pivotably attached to the hinge plate and is operable to rotate about a pivot axis between the locked condition and the unlocked condition.

18. The door latch assembly according to claim 17,
wherein the hinge plate includes a yoke bracket having upper and lower horizontally opposed flanges, wherein each of the upper and lower horizontally opposed flanges includes a pivot aperture extending through a respective one of the upper and lower horizontally opposed flanges;
wherein the pivot apertures on each of the upper and lower horizontally opposed flanges are vertically aligned and centered on a vertical axis;
wherein the pivot latch includes a pivot bar that is received in the pivot apertures on each of the upper and lower horizontally opposed flanges; and
wherein the lower flange of the yoke bracket includes a corner notch that defines a first ledge and a second ledge of the lower flange.

19. The door latch assembly according to claim 18,
wherein the first ledge and the second ledge each extend outward from the vertical axis;
wherein a first perimeter wall of the first ledge and a second perimeter wall of the second ledge intersect at approximately 90 degrees and define boundaries of the corner notch;
wherein the pivot latch generally includes a latch plate and the pivot bar;
wherein the latch plate includes a locking shoulder located at a lower side of a proximal end of the latch plate;
wherein the locking shoulder is configured such that at the locking shoulder a height of a first leg of the latch plate is equal to a height of a second leg of the latch plate;
wherein the locking shoulder of the latch plate is co-operable with the corner notch of the lower flange of the yoke bracket to fix the pivot latch in a locking position;
wherein the pivot bar is attached to and along the second leg of the latch plate at or near a distal end of the second leg;
wherein, in the locked condition, the pair of sliding doors are secured and closed and cannot open; and
wherein in the unlocked condition, the sliding doors are free to move between the opened and closed positions.

20. The shelving unit according to claim 2 further comprising the door latch assembly according to claim 17.
